(19) United States
(12) Patent Application Publication
(10) Pub. No.: US 2012/0081582 A1
(43) Pub. Date: Apr. 5, 2012

(54) CONTENT PROCESSING APPARATUS

(75) Inventors: Hideki MATSUMURA, Osaka (JP); Yasushi Miyagawa, Osaka (JP)

(73) Assignee: Sanyo Electric Co., Ltd., Osaka (JP)

(21) Appl. No.: 13/243,181

(22) Filed: Sep. 23, 2011

(30) Foreign Application Priority Data
Oct. 4, 2010 (JP) 2010-224989

(51) Int. Cl. H04N 5/262

(52) U.S. Cl. 348/239; 348/E05.051

(57) ABSTRACT

A content processing apparatus includes a plurality of first outputters. A plurality of first outputters respectively output a plurality of first contents. Each of a plurality of selectors selects any one of the plurality of first contents respectively outputted from the plurality of first outputters. A composer composes the plurality of first contents respectively outputted from the plurality of selectors. A controller controls a selection manner of each of the plurality of selectors so as to be different depending on a mode.

### CROSS REFERENCE OF RELATED APPLICATION

The disclosure of Japanese Patent Application No. 2010-224989, which was filed on Oct. 4, 2010, is incorporated here by reference.

### BACKGROUND OF THE INVENTION

1. Field of the Invention

The present invention relates to a content processing apparatus. More particularly, the present invention relates to a content processing apparatus which composes a plurality of contents.

2. Description of the Related Art

According to one example of this type of apparatus, an electronic camera is configured by a camera section and a main body section. The camera section incorporates a shooting lens and an imaging section, and is combined with the main body section via a connecting section. A monitor display section is arranged on a rear surface of the main body section. Moreover, a character signal generating circuit which generates a signal corresponding to various character displays such as a distinction between a standard and a macro and remaining frames for photographing is arranged in the main body section. A character signal selected in a selecting circuit is inputted into a mixing circuit together with an image signal for display of an output system in the camera section. A composed screen signal for display generated by the mixing circuit is supplied to a driving circuit. As a result, an observation screen and a character display screen are displayed on the monitor display section in a state where they are overlapped.

However, in the above-described apparatus, only a case where two contents of the character signal and the image signal for display are composed and displayed on the monitor is described, but not a case where more than three contents are composed is described. Thus, in the above-described apparatus, a manner of the composed content may be limited in a case where the more than three contents are prepared.

### SUMMARY OF THE INVENTION

A content processing apparatus according to the present invention, comprises: a plurality of first outputters which respectively output a plurality of first contents; a plurality of selectors each of which selects any one of the plurality of first contents respectively outputted from said plurality of first outputters; a composer which composes the plurality of first contents respectively outputted from said plurality of selectors; and a controller which controls a selection manner of each of said plurality of selectors so as to be different depending on a mode.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is a block diagram showing one example of a configuration of a character generator;

FIG. 4 is a block diagram showing one example of a configuration of a display driver;

FIG. 5 (A) is an illustrative view showing one example of a composing process executed by a composing circuit;

FIG. 5 (B) is an illustrative view showing another example of the composing process executed by the composing circuit;

FIG. 5 (C) is an illustrative view showing still another example of the composing process executed by the composing circuit;

FIG. 5 (D) is an illustrative view showing yet another example of the composing process executed by the composing circuit;

FIG. 5(E) is an illustrative view showing another example of the composing process executed by the composing circuit; and

FIG. 6 is a flowchart showing one portion of behavior of a CPU applied to the embodiment in FIG. 2.

### DETAILED DESCRIPTION OF THE PREFERRED EMBODIMENTS

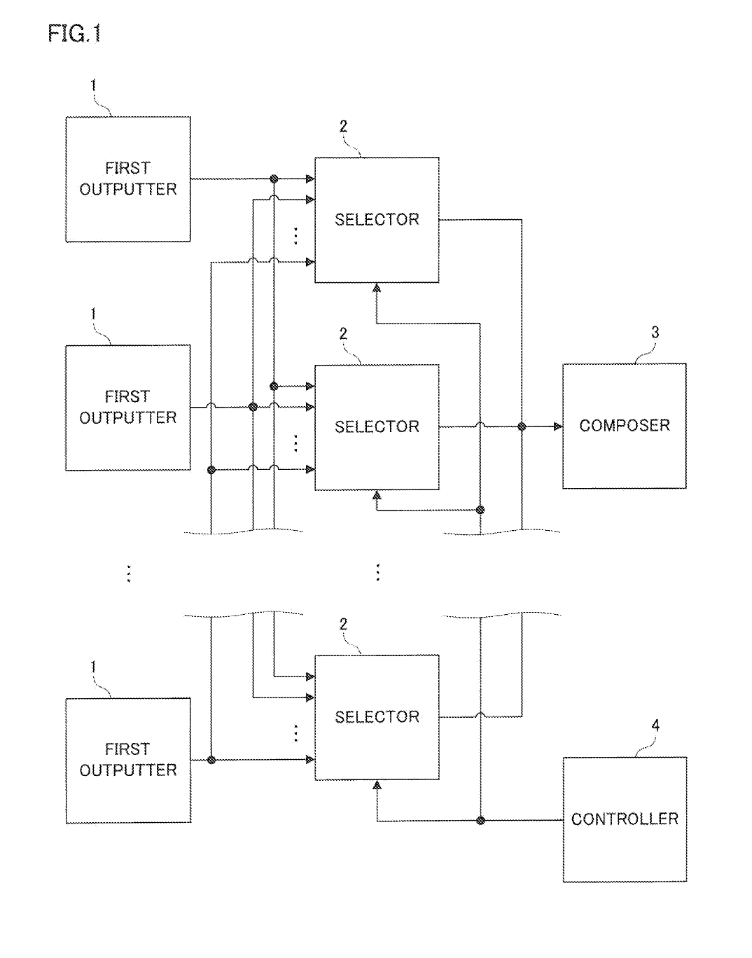

With reference to FIG. 1, a content processing apparatus according to one embodiment of the present invention is basically configured as follows: A plurality of first outputters 1, 1, . . . respectively output a plurality of first contents. Each of a plurality of selectors 2, 2, . . . selects any one of the plurality of first contents respectively outputted from the plurality of first outputters 1, 1, . . . . A composer 3 composes the plurality of first contents respectively outputted from the plurality of selectors 2, 2, . . . . A controller 4 controls a selection manner of each of the plurality of selectors 2, 2, . . . so as to be different depending on a mode.

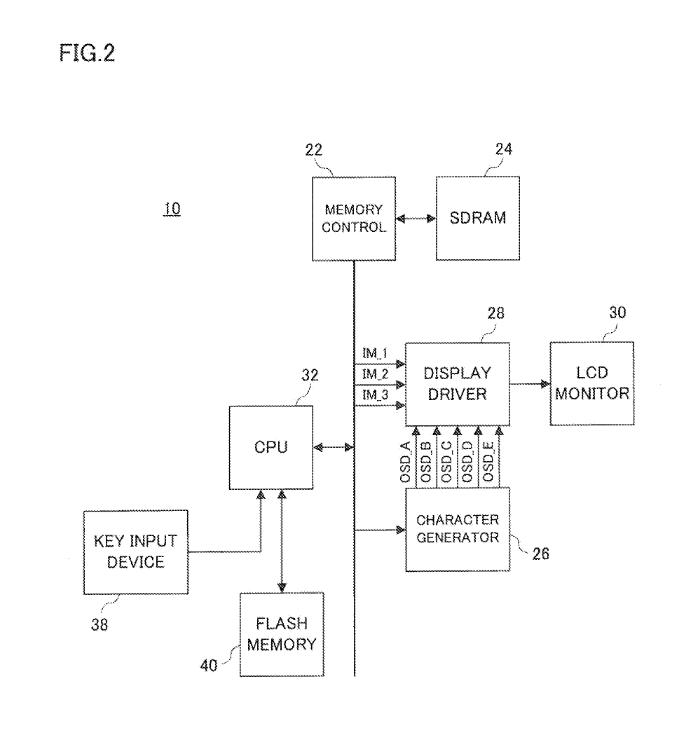

With reference to FIG. 2, an image processing apparatus 10 according to this embodiment includes an SDRAM 24 which accommodates camera image data IM_1 to IM_3. A display driver 28 reads out the camera image data IM_1 to IM_3 accommodated in the SDRAM 24 through a memory control circuit 22. A CPU 32 applies a corresponding command to a character generator 26 in order to display a plurality of character images together with a camera image on an LCD monitor 30. According to the applied command, the character generator 26 creates character image data OSD_A to OSD_E so as to apply the created character image data OSD_A to OSD_E to the display driver 28.

The display driver 28 composes the camera image data IM_1 to IM_3 read out from the SDRAM 24 and the character image data OSD_A to OSD_E created by the character generator 28 so as to create composed image data. The LCD monitor 30 is driven based on the created composed image data, and as a result, a corresponding composed image is displayed on the LCD monitor 30.

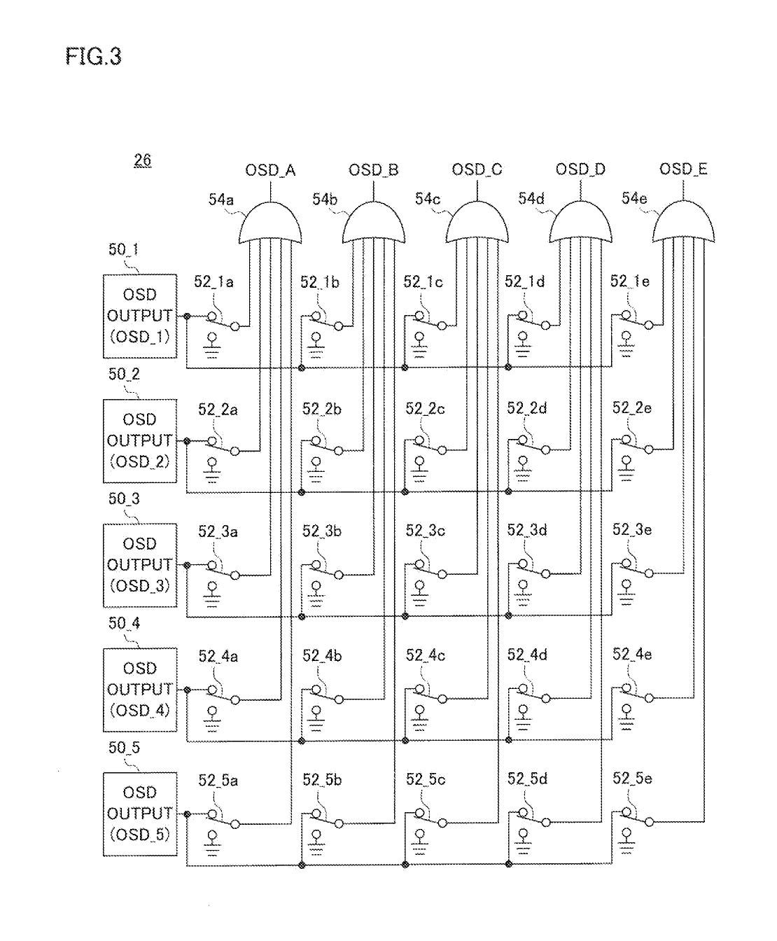

The character generator 26 is configured as shown in FIG. 3. Character image data OSD_1 to OSD_5 are respectively outputted from OSD output circuits 50_1 to 50_5.

Switches 52_1a to 52_1e determine whether or not to supply the character image data OSD_1 outputted from the OSD output circuit 50_1 to OR circuits 54a to 54e. Switches 52_2a to 52_2e determine whether or not to supply the character image data OSD_2 outputted from the OSD output circuit 502 to the OR circuits 54a to 54e. Switches 52_3a to 52_3e determine whether or not to supply the character image data OSD_3 outputted from the OSD output circuit 50_3 to the OR circuits 54a to 54e. Switches 52_4a to 52_4e determine whether or not to supply the character image data OSD_4 outputted from the OSD output circuit 50_4 to the OR circuits 54a to 54e. Switches 52_5a to 52_5e determine whether or not to supply the character image data OSD_5 outputted from the OSD output circuit 505 to the OR circuits 54a to 54e.

It is noted that, according to the command of the CPU 32, each of switches 52_1a, 52_2a, 52_3a, 52_4a and 52_5a is controlled so that any one of the switches becomes an on-state. As a result, any one of the character image data OSD_1 to OSD_5 respectively outputted from the OSD output circuits 50_1 to 50_5 is applied to the OR circuit 54a.

Each of switches 52_1b, 52_2b, 52_3b, 52_4b and 52_5b is also controlled similarly. As a result, any one of the character image data OSD_1 to OSD_5 respectively outputted from the OSD output circuits 50_1 to 50_5 is applied to the OR circuit 54b.

Each of switches 52_1c, 52_2c, 52_3c, 52_4c and 52_5c is also controlled similarly. As a result, any one of the character image data OSD_1 to OSD_5 respectively outputted from the OSD output circuits 50_1 to 50_5 is applied to the OR circuit 54c.

Each of switches 52_1d, 52_2d, 52_3d, 52_4d and 52_5d is also controlled similarly. As a result, any one of the character image data OSD_1 to OSD_5 respectively outputted from the OSD output circuits 50_1 to 50_5 is applied to the OR circuit 54d.

Each of switches 52_1e, 52_2e, 52_3e, 52_4e and 52_5e is also controlled similarly. As a result, any one of the character image data OSD_1 to OSD_5 respectively outputted from the OSD output circuits 50_1 to 50_5 is applied to the OR circuit 54e.

The OR circuits 54a to 54e respectively output the applied character image data as the character image data OSD_A to OSD_E.

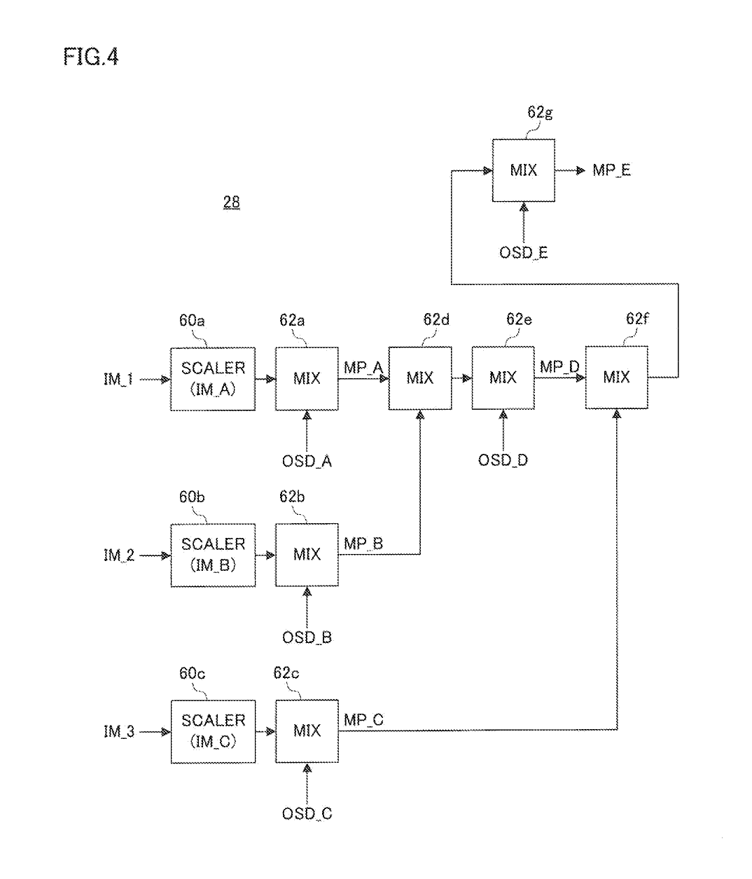

The display driver 28 is configured as shown in FIG. 4. Scalers 60a to 60c perform a zoom process referring to scaler coefficients set by the CPU 32, on the camera image data IM_1 to IM_3 read out from the SDRAM 24. It is noted that the scaler coefficients set to the scalers 60a to 60c are mutually different coefficients. As a result, camera image data IM_A to IM_C having mutually different sizes are respectively outputted from the scalers 60a to 60c.

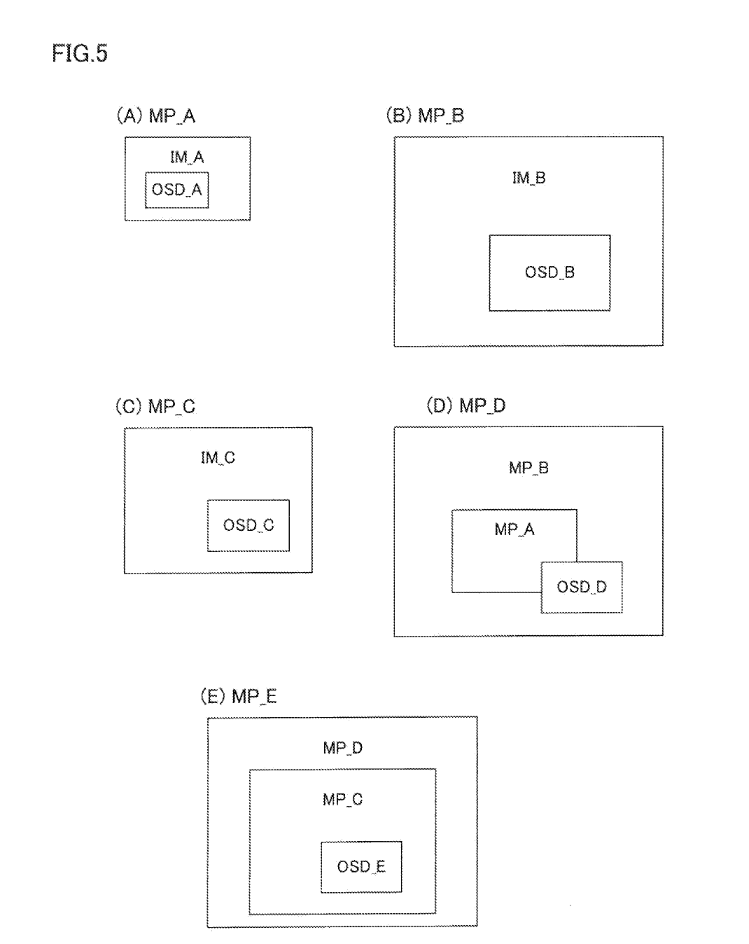

A composing circuit 62a composes the camera image data IM_A outputted from the scaler 60a and the character image data OSD_A outputted from the character generator 26 so as to generate composed image data MP_A (see FIG. 5 (A)). A composing circuit 62b composes the camera image data IM_B outputted from the scaler 60b and the character image data OSD_B outputted from the character generator 26 so as to generate composed image data MP_B (see FIG. 5 (B)). A composing circuit 62c composes the camera image data IM_C outputted from the scaler 60c and the character image data OSD_C outputted from the character generator 26 so as to generate composed image data MP_C (see FIG. 5 (C)).

A composing circuit 62d composes the composed image data MPA outputted from the composing circuit 62a and the composed image data MP_B outputted from the composing circuit 62b. Furthermore, a composing circuit 62e composes the character image data OSD_D outputted from the character generator 26. As a result, composed image data MP_D is generated (see FIG. 5 (D)). A composing circuit 62f composes the composed image data MP_D outputted from the composing circuit 62e and the composed image data MP_C outputted from the composing circuit 62c. Furthermore, a composing circuit 62g composes the character image data OSD_E outputted from the character generator 26. As a result, composed image data MP_E is generated and applied to the LCD monitor 30 (see FIG. 5 (E)).

Moreover, each of the composing circuits 62a to 62g executes a composing process with reference to a transmissivity set by the CPU 32.

On the other hand, three modes are prepared for the image processing apparatus 10. The three modes are mutually switched by an operator operating a key input device 38. Any one of the three modes is designated by such mode changeover operation. Settings of the switches 52_1a to 52_5e and settings of the transmissivity upon the composing process executed by the composing circuits 62a to 62g are controlled based on a designated mode.

When “mode 1” is designated, the settings of the switches 52_1a to 52_5e and the settings of the transmissivity upon the composing process executed by the composing circuits 62a to 62g are controlled as follows. The CPU 32 commands the switch 52_1a to become the on-state, and commands each of the switches 52_2a, 52_3a, 52_4a and 52_5a to become an off-state. As a result, the character image data OSD_1 outputted from the OSD output circuit 50_1 is applied to the OR circuit 54a so as to be outputted as the character image data OSD_A. Moreover, the CPU 32 commands the switch 52_2b to become the on-state, and commands each of the switches 52_1b, 52_3b, 52_4b and 52_5b to become the off-state. As a result, the character image data OSD_2 outputted from the OSD output circuit 50_2 is applied to the OR circuit 54b so as to be outputted as the character image data OSD_B.

Moreover, the CPU 32 commands the switch 52_3c to become the on-state, and commands each of the switches 52_1c, 52_2c, 52_4c and 52_5c to become the off-state. As a result, the character image data OSD_3 outputted from the OSD output circuit 50_3 is applied to the OR circuit 54c so as to be outputted as the character image data OSD_C. Moreover, the CPU 32 commands the switch 52_4d to become the on-state, and commands each of the switches 52_1d, 52_2d, 52_3d and 52_5d to become the off-state. As a result, the character image data OSD_4 outputted from the OSD output circuit 50_4 is applied to the OR circuit 54d so as to be outputted as the character image data OSD_D. Moreover, the CPU 32 commands the switch 52_5e to become the on-state, and commands each of the switches 52_1e, 52_2e, 52_3e and 52_4e to become the off-state. As a result, the character image data OSD_5 outputted from the OSD output circuit 50_5 is applied to the OR circuit 54e so as to be outputted as the character image data OSD_E.

The CPU 32 sets a transmissivity of “0.5:0.5” to each of the composing circuits 62a to 62g. Each of the composing circuits 62a to 62g executes the composing process based on the set transmissivity of “0.5:0.5”.

When “mode 2” is designated, the settings of the switches 52_1a to 52_5e and the settings of the transmissivity upon the composing process executed by the composing circuits 62a to 62g are controlled as follows. The CPU 32 commands the switch 52_1a to become the on-state, and commands each of the switches 52_2a, 52_3a, 52_4a and 52_5a to become an off-state. Moreover, the CPU 32 commands the switch 52_1b to become the on-state, and commands each of the switches 52_2b, 52_3b, 52_4b and 52_5b to become the off-state. Moreover, the CPU 32 commands the switch 52_1c to become the on-state, and commands each of the switches 52_2c, 52_3c, 52_4c and 52_5c to become the off-state. As a result, the character image data OSD_1 outputted from the OSD output circuit 50_1 is applied to the OR circuits 54a, 54b and 54c so as to be outputted as the character image data OSD_A, OSD_B and OSD_C, respectively.

Moreover, the CPU 32 commands the switch 52_2d to become the on-state, and commands each of the switches 52_1d, 52_3d, 52_4d and 52_5d to become the off-state. As a result, the character image data OSD_2 outputted from the OSD output circuit 50_2 is applied to the OR circuit 54d so as to be outputted as the character image data OSD_D. Moreover, the CPU 32 commands the switch 52_3e to become the on-state, and commands each of the switches 52_1e, 52_2e, 52_4e and 52_5e to become the off-state. As a result, the character image data OSD_3 outputted from the OSD output circuit 50_3 is applied to the OR circuit 54e so as to be outputted as the character image data OSD_E.

The CPU 32 sets the transmissivity of “0.5:0.5” to each of the composing circuits 62a to 62c, 62e and 62g. Each of the composing circuits 62a to 62c, 62e and 62g executes the composing process based on the set transmissivity of “0.5:0.5”. Moreover, the CPU 32 sets a transmissivity of “0.7” for the composed image data MLA and a transmissivity of “0.3” for the composed image data MP_B, to the composing circuit 62d. The composing circuit 62d executes the composing process based on the set transmissivity of “0.7:0.3”. The CPU 32 sets the transmissivity of “0.3” for the composed image data MP_D and a transmissivity of “0.7” for the composed image data MP_C, to the composing circuit 62f. The composing circuit 62f executes the composing process based on the set transmissivity of “0.3:0.7”.

When “mode 3” is designated, the settings of the switches 52_1a to 52_5e and the settings of the transmissivity upon the composing process executed by the composing circuits 62a to 62g are controlled as follows. Similarly to a case of the “mode 1”, the CPU 32 issues the command toward the switches 52_1a to 52_5e. As a result, the character image data OSD_1 is outputted as the character image data OSD_A, the character image data OSD_2 is outputted as the character image data OSD_B, the character image data OSD_3 is outputted as the character image data OSD_C, the character image data OSD_4 is outputted as the character image data OSD_D, and the character image data OSD_5 is outputted as the character image data OSD_E.

The CPU 32 sets the transmissivity of“0.5:0.5” to each of the composing circuits 62a to 62d and 62f Each of the composing circuits 62a to 62d and 62f executes the composing process based on the set transmissivity of “0.5:0.5”.

Moreover, the CPU 32 sets a transmissivity of “1” for the composed image data outputted from the composing circuit 62d and a transmissivity of “0” for the character image data OSD_D, to the composing circuit 62e. The composing circuit 62e executes the composing process based on the set transmissivity of “1:0”. As a result, the character image data OSD_D in which the transmissivity is set to “0” is not included in the generated composed image data MP_D. Moreover, the CPU 32 sets the transmissivity of “1” for the composed image data outputted from the composing circuit 62f and the transmissivity of “0” for the character image data OSD_E, to the composing circuit 62g. The composing circuit 62g executes the composing process based on the set transmissivity of “1:0”. As a result, the character image data OSD_E in which the transmissivity is set to “0” is not included in the generated composed image data MP_E.

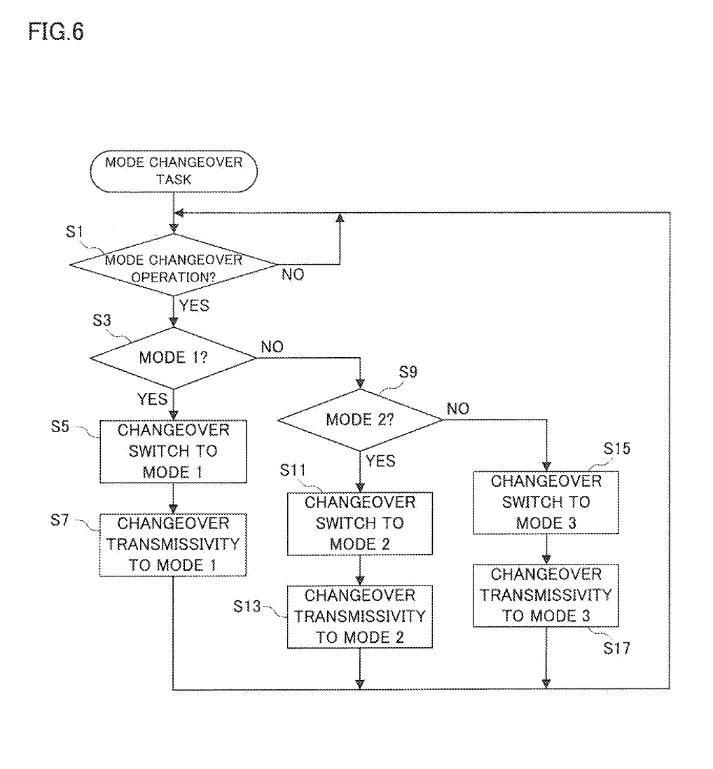

The CPU 32 executes a mode changeover task shown in FIG. 6. It is noted that, a control program corresponding to the task is stored in a flash memory 40.

With reference to FIG. 6, in a step S1, it is determined whether or not the mode changeover operation is performed. When a determined result is updated from NO to YES, in a step S3, it is determined whether or not the “mode 1” is designated. When a determined result of the step S3 is YES, in a step S5, each of the switches 52_1a, 52_2b, 52_3c, 52_4d and 52_5e is commanded to become the on-state, and each of the other switches is commanded to become the off-state.

As a result, the character image data OSD_1 is outputted from the OR circuit 54a as the character image data OSD_A, the character image data OSD_2 is outputted from the OR circuit 54b as the character image data OSD_B, the character image data OSD_3 is outputted from the OR circuit 54c as the character image data OSD_C, the character image data OSD_4 is outputted from the OR circuit 54d as the character image data OSD_D, and the character image data OSD_5 is outputted from the OR circuit 54e as the character image data OSD_E.

In a step S7, the transmissivity of “0.5:0.5” is set to each of the composing circuits 62a to 62g. As a result, each of the composing circuits 62a to 62g executes the composing process based on the set transmissivity of “0.5:0.5”.

When the determined result of the step S3 is NO, in a step S9, it is determined whether or not the “mode 2” is designated. When a determined result of the step S9 is YES, in a step S11, each of the switches 52_1a, 52_1b, 52_1c, 52_2d and 52_3e is commanded to become the on-state, and each of the other switches is commanded to become the off-state.

As a result, the character image data OSD_1 is outputted from the OR circuits 54a, 54b and 54c as the character image data OSD_A, OSD_B and OSD_C, respectively, the character image data OSD_2 is outputted from the OR circuit 54d as the character image data OSD_D, and the character image data OSD_3 is outputted from the OR circuit 54e as the character image data OSD_E.

In a step S13, the transmissivity of “0.5:0.5” is set to each of the composing circuits 62a to 62c, 62e and 62g, the transmissivity of “0.7:0.3” is set to the composing circuit 62d, and the transmissivity of “0.3:0.7” is set to the composing circuit 62f. As a result, each of the composing circuits 62a to 62g executes the composing process based on the set transmissivity.

When both of the determined results of the steps S3 and S9 are NO, it is determined that the “mode 3” is designated, and thereafter, the process advances to a step S15. In the step S15, each of the switches 52_1a, 52_2b, 52_3c, 52_4d and 52_5e is commanded to become the on-state, and each of the other switches is commanded to become the off-state.

As a result, the character image data OSD_1 is outputted from the OR circuit 54a as the character image data OSD_A, the character image data OSD_2 is outputted from the OR circuit 54b as the character image data OSD_B, the character image data OSD_3 is outputted from the OR circuit 54c as the character image data OSD_C, the character image data OSD_4 is outputted from the OR circuit 54d as the character image data OSD_D, and the character image data OSD_5 is outputted from the OR circuit 54e as the character image data OSD_E.

In a step S17, the transmissivity of “0.5:0.5” is set to each of the composing circuits 62a to 62d and 62f, the transmissivity of “1:0” is set to the composing circuits 62e and 62g. As a result, each of the composing circuits 62a to 62g executes the composing process based on the set transmissivity. Moreover, the character image data OSD_D in which the transmissivity is set to “0” is not included in the composed image data MP_D, and the character image data OSD_E in which the transmissivity is set to “0” is not included in the composed image data MP_E.

Upon completion of the processes in the steps S7, S13 and S17, the process returns to the step S1.

As can be seen from the above described explanation, the OSD output circuits 50_1 to 50_5 respectively outputs the character image data OSD_1 to OSD_5. Each of the switches 52_1a to 52_5e and the OR circuits 54a to 54e selects any one of the character image data OSD_1 to OSD_5 respectively outputted from the OSD output circuits 50_1 to 50_5. The composing circuits 62a to 62g compose the character image data OSD_A to OSD_E respectively outputted from the OR circuits 54a to 54e. The CPU 32 controls a selection manner of each of the switches 52_1a to 52_5e and the OR circuits 54a to 54e so as to be different depending on the mode.

Thus, when the number of the OSD output circuits is assumed “K” and the number of the OR circuits is assumed “L”, K*L of combinations are secured as combinations of the character image data applied to the composing circuits. The controller selects a combination corresponding to a mode at a current time point from among the K*L of combinations. Thereby, it becomes possible to improve a diversity of the composed image data.

It is noted that, in this embodiment, based on the designated mode out of the three modes “mode 1” to “mode 3”, the settings of the switches 52_1a to 52_5e and the settings of the transmissivity upon the composing process executed by the composing circuits 62a to 62g are controlled. However, the number of the modes may be other than three.

Moreover, in this embodiment, the character image data OSD_1 to OSD_5 are respectively outputted from five OSD output circuits of the OSD output circuits 50_1 to 50_5, and the character image data OSD_A to OSD_E are respectively outputted from five OR circuits of the OR circuits 54a to 54e. However, the number of each of the OSD output circuits and the OR circuits may be other than five.

Moreover, in this embodiment, each of seven composing circuits of the composing circuits 62a to 62g executes the composing process for the image data. However, the number of the composing circuits may be other than seven.

Moreover, in this embodiment, the camera image data and the character image data are composed and thereafter, displayed on the LCD monitor 30. However, the composed image data may be outputted to an external.

Moreover, in this embodiment, the composing process for the image data is executed in the image processing apparatus 10. However, a composing process for a content other than the image data such as sound data may be executed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content processing apparatus, comprising:
a plurality of first outputters which respectively output a plurality of first contents;
a plurality of selectors each of which selects any one of the plurality of first contents respectively outputted from said plurality of first outputters;
a composer which composes the plurality of first contents respectively outputted from said plurality of selectors; and
a controller which controls a selection manner of each of said plurality of selectors so as to be different depending on a mode.

2. A content processing apparatus according to claim 1, wherein the number of said selectors is equivalent to the number of said first outputters.

3. A content processing apparatus according to claim 1, further comprising a plurality of second outputters which respectively output a plurality of second contents, wherein said composer composes the plurality of first contents respectively outputted from said plurality of selectors and the plurality of second contents respectively outputted from said plurality of second outputters.

4. A content processing apparatus according to claim 3, further comprising a designator which designates a weighted amount, wherein said composer composes the plurality of first contents and the plurality of second contents according to the weighted amount designated by said designator.

5. A content processing apparatus according to claim 3, wherein any of the plurality of first contents respectively outputted from said plurality of first ouputters and the plurality of second contents respectively outputted from said plurality of second outputters is equivalent to an image, and the weighted amount designated by said designator is equivalent to a transmissivity.

6. A content processing apparatus according to claim 3, wherein the first content is equivalent to a character image, and the second content is equivalent to a camera image.
